(19) United States
(12) Patent Application Publication
(10) Pub. No.: US 2024/0152534 A1
(43) Pub. Date: May 9, 2024

(54) METHOD AND SYSTEM FOR RETRIEVAL OF CONTEXTUAL INFORMATION RELATED TO UNMET MEDICAL NEED OF AN INDICATION

(71) Applicant: Innoplexus AG, Eschborn (DE)

(72) Inventors: Vinay Chandil, Gwalior (IN); Om Sharma, Pune (IN)

(73) Assignee: Innoplexus AG, Eschborn (DE)

(21) Appl. No.: 17/981,826

(22) Filed: Nov. 7, 2022

(51) Int. Cl. G06F 16/30; G10L 15/30

(52) U.S. Cl. CPC G06F 16/30; G10L 15/30

(57) ABSTRACT

A method and system for retrieval of contextual information related to unmet medical need of an indication. The identification of unmet medical need of an indication becomes a critical information in the drug discovery process. The system for retrieval of contextual information related to unmet medical need of an indication enables providing assistance to scientists through digital pharma. The method comprises scanning plurality of medical literature documents to extract and tokenize the documents into plurality of sentences. The scanned plurality of sentences is modelled, by one or more processors, to identify contextually labelled one or more sentences comprising indications, one or more unmet medical need categories, one or more unmet medical need attributes. The plurality of sentences is modelled using one or more of natural language processing techniques and supervised ML classifier. The modelled contextually labelled one or more sentences, the indications, one or more unmet medical need categories, one or more unmet medical need attributes are indexed to retrieve the contextual information related to the unmet medical needs of the indications.

### FIELD OF TECHNOLOGY

Certain embodiments of the disclosure relate to retrieval of contextual information related to unmet medical need of an indication. More specifically, certain embodiments of the disclosure relate to method and system for retrieval of contextual information related to unmet medical need of an indication.

### BACKGROUND

The Food and Drug Administration (FDA) defines unmet medical need as a condition whose treatment or diagnosis is not addressed adequately by available therapy. Unmet medical need includes conditions for which there are no available therapy, or even when where there is available therapy.

When available therapy exists for a condition, a new treatment generally would be considered to address an unmet medical need if the treatment—Has an improved effect on a serious outcome(s) of the condition compared with available therapy, provides efficacy comparable to those of available therapy, provides safety and efficacy comparable to those of available therapy but has a documented benefit, such as improved compliance, that is expected to lead to an improvement in serious outcomes. For example, in a condition for which there are approved therapies that have a modest response rate or significant heterogeneity in response, a drug with a novel mechanism of action could have the potential to provide an advantage over available therapy in some patients.

Typically, identification of such conditions or indications in view of the effect or outcome becomes a critical information in the drug discovery process. Many publications including surveys, articles, reports and other medical literatures indicates unmet medical needs.

Additionally, development in the Informatics methods, such as text mining and natural language processing, has enriched the bioinformatics research in providing database on unmet medical need. However, providing information with little or no context between the indications and the unmet medical needs would be inadequate for the purpose.

Further limitations and disadvantages of conventional and traditional approaches will become apparent to one of skill in the art, through comparison of such systems with some aspects of the present disclosure as set forth in the remainder of the present application with reference to the drawings.

### OBJECT OF THE INVENTION

The objective of the invention is to retrieve contextual information related to unmet medical need of an indication from plurality of documents.

Another objective of the invention is to accurately associate the indications with one or more unmet need attributes associated with the indications mentioned in the plurality of documents.

Yet another objective of the invention is to contextually identify sentences which are associated with the indications and the one or more unmet need attributes.

Further objective of the invention is to efficiently identify contexts between the indications and the attributes mentioned in one or more sentences of the plurality of documents.

Furthermore, another objective of the invention is to display recent and authentic one or more medical literature documents containing accurate and contextually relevant indications and one or more attributes associated with the indications.

Moreover, another objective of the invention is to reduce processing time for displaying search results for one of the indications, unmet need categories or the attributes to identify unmet medical needs.

### BRIEF SUMMARY OF THE DISCLOSURE

A method is disclosed for identifying unmet medical need of an indication, substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF SEVERAL VIEWS OF THE DRAWINGS

FIG. 1 is a block diagram that illustrates an exemplary system for identifying unmet medical need of an indication, in accordance with an exemplary embodiment of the disclosure.

FIGS. 2A, 2B and 2C depicts visual representation of the outputs derived from the various implementations of one or more machine learning classifier and one or more name entity recognition techniques in identification of unmet medical needs of an indication, in accordance with an exemplary embodiment of the disclosure.

FIGS. 3A and 3B depict flowcharts illustrating exemplary operations for identifying unmet medical needs of an indication, in accordance with various exemplary embodiments of the disclosure.

FIG. 4 is a conceptual diagram illustrating an example of a hardware implementation for a system employing a processing system for identifying unmet medical need of an indication, in accordance with an exemplary embodiment of the disclosure.

### DETAILED DESCRIPTION OF THE DISCLOSURE

Certain embodiments of the disclosure relate to retrieval of contextual information related to unmet medical need of an indication. The concept of unmet medical need (UMN) is meant to help the research and healthcare communities distinguish more pressing patient and societal health needs from the myriad of other health needs. In the context of the current invention, the unmet medical need is being computationally identified from a plurality of documents using method claimed herein.

The Unmet medical needs are associated with relevant indications. An indication is a medical condition that a medicine is used for. This can include the treatment, prevention and diagnosis of a disease. In particular, a condition which makes a particular treatment or procedure advisable. In an embodiment, CIVIL (chronic myeloid leukemia) is an indication for the use of Gleevec (imatinib mesylate). Indication also includes a sign or a circumstance which points to or shows the cause, pathology, treatment, or outcome of an attack of disease. In an example, the presence of the Philadelphia chromosome in peripheral blood cells is an indication of a relapse in CML. The unmet medical need of the indication comprises of one or more medical literature documents containing indications along with the associated one or more unmet medical need categories, one or more unmet medical need attributes which are abnormal. The abnormality of the unmet medical need associated with the indications is based on comparison between the extracted information from the one or medical publications and pre-defined threshold associated with the one or more unmet need attributes.

Various embodiments of the disclosure provide a method and system for retrieval of contextual information related to unmet medical need of an indication. Beneficially, the identifications of the unmet medical need of the indications inter alia, help companies identify which indications have high unmet deed in the therapeutic space, know which indications have emerging unmet need. Further beneficially, the indications of the unmet medical need help the scientists and researchers to—understand which indications are less researched based on “low understanding of disease pathophysiology” like labels and similar works in this domain, get a complete picture on the requirements of the research needed to improve treatment in a particular indication like diagnostic, therapeutic, molecular level. The solutions in the present disclosure identifies accurate and contextually relevant documents to find the unmet medical needs of the indication. The solutions also enable efficient retrieval of documents to help companies and researchers focus on the key indications to solve the unmet medical needs.

In accordance with various embodiments of the disclosure, a method is provided for retrieval of contextual information related to unmet medical need of an indication. The method comprises scanning, by one or more processors, plurality of medical literature documents to extract and tokenize text from the documents into plurality of sentences. The method comprises modelling, by one or more processors, the plurality of sentences to identify contextually labelled one or more sentences comprising indications, one or more unmet medical need categories, one or more unmet medical need attributes, wherein the plurality of sentences are modelled using one or more of natural language processing techniques and supervised ML classifier. The method further comprises indexing, by one or more processors, the modelled contextually labelled one or more sentences, the indications, one or more unmet medical need categories, one or more unmet medical need attributes to retrieve the contextual information related to the unmet medical needs of the indications.

In accordance with an embodiment, the model comprises at least one natural language processing techniques comprising bag of words model operable to identify one or more sentences comprising an indication and one or more unmet medical need categories from the plurality of sentences, a domain specific ontology operable to contextually identify the indication, one or more unmet medical need categories and one or more unmet medical need attributes, and at least one supervised ML classifier operable to label the identified one or more sentences with one or more unmet medical need attributes corresponding to the one or more unmet medical need categories

In accordance with an embodiment, wherein the method comprises tagging, by one or more processors, the identified one or more sentences with metadata of the respective medical literature documents.

In accordance with an embodiment, the method comprises of generating, by one or more processors, a source confidence score for the respective plurality of medical literature documents based on recency of the document and impact factor of the medical literature document.

In accordance with an embodiment, the method comprises aggregating, by one or more processors, the medical literature documents based on the contextually labelled one or more sentences and the source confidence score.

In accordance with an embodiment, the method comprises crawling, by one or more processors, plurality of data sources to extract plurality of medical literature documents.

In accordance with an embodiment, wherein the indications, one or more unmet medical need categories, and the one or more unmet medical need attributes are pre-defined, wherein the one or more unmet medical need attributes comprises of efficacy, targets, Route of administration, No or less therapeutic, diagnostic unavailable.

In accordance with an embodiment, the method comprises applying, by one or more processors, one or more algorithms to identify synonyms and abbreviations for the indications, one or more unmet medical need categories, and the one or more unmet medical need attributes to identify the one or more sentences.

In accordance with an embodiment, the method comprises displaying, by one or more processors, one or more medical literature documents for queries corresponding to one of the indications or the one or more unmet medical need attributes based on the index.

In accordance with an embodiment, the medical literature documents comprise of survey data, healthcare news, articles, guidelines, SOC documents, experimental data.

In accordance with another aspect of the disclosure, a system for retrieval of contextual information related to unmet medical need of an indication. The system comprises at least one server communicably coupled with a plurality of data sources and a database. The server comprising one or more processors configured to scan a plurality of medical literature documents from the plurality of data sources to tokenize the documents into plurality of sentences, model the plurality of sentences to identify contextually labelled one or more sentences comprising indications, one or more unmet medical need categories, one or more unmet medical need attributes, wherein the plurality of sentences are modelled using one or more of natural language processing techniques and supervised ML classifier, and index the modelled contextually relevant one or more sentences, the indications, one or more unmet medical need categories, one or more unmet medical need attributes to retrieve the one or more medical literature documents and contextual information related to the unmet medical needs of the indications. The database arrangement is configured to store the index for query-based retrieval of the aggregated contextual information related to unmet medical need of an indication.

In accordance with an embodiment, the model comprises at least one natural language processing techniques comprising bag of words model operable to identify one or more sentences comprising an indication and one or more unmet medical need categories from the plurality of sentences, a domain specific ontology operable to contextually identify the indication, one or more unmet medical need categories and one or more unmet medical need, and at least one supervised ML classifier operable to label the identified one or more sentences with one or more unmet medical need attributes corresponding to the one or more unmet medical need categories.

In accordance with an embodiment, the at least one server comprising one or more processors configured to tag the identified one or more sentences with metadata of the respective medical literature documents.

In accordance with an embodiment, the at least one server comprising one or more processors configured to generate a source confidence score for the respective plurality of medical literature documents based on recency of the document and impact factor of the medical literature document.

In accordance with an embodiment, the at least one server comprising one or more processors configured to aggregate the medical literature documents based on the contextually labelled one or more sentences and the source confidence score.

In accordance with an embodiment the at least one server comprising one or more processors configured to crawl the plurality of data sources to extract plurality of medical literature documents.

In accordance with an embodiment, the indications, one or more unmet medical need categories, and the one or more unmet medical need attributes are pre-defined, wherein the one or more unmet medical need attributes comprises of efficacy, targets, route of administration, no or less therapeutic, diagnostic unavailable.

In accordance with an embodiment, the at least one server comprises one or more processors configured to apply one or more algorithms to identify synonyms and abbreviations for the indications, one or more unmet medical need categories, and the one or more unmet medical need attributes to identify the one or more sentences

In accordance with an embodiment, the at least one server comprises one or more processors configured to display the contextual information related to the unmet medical needs of the indications for queries corresponding to one of the indications or the one or more unmet medical need attributes based on the index.

In accordance with another aspect of the disclosure, a computer program product comprising a computer useable medium having computer program logic recorded thereon for enabling a processor to retrieve contextual information related to unmet medical need of an indication. The computer program product comprising of a computer program logic scanning the plurality of medical literature documents to tokenize the documents into plurality of sentences, modelling the plurality of sentences to identify contextually labelled one or more sentences comprising indications, one or more unmet medical need categories, one or more unmet medical need attributes, wherein the plurality of sentences are modelled using one or more of natural language processing techniques and supervised ML classifier, and index the modelled contextually labelled one or more sentences, the indications, one or more unmet medical need categories, one or more unmet medical need attributes to retrieve the contextual information related to the unmet medical needs of the indications.

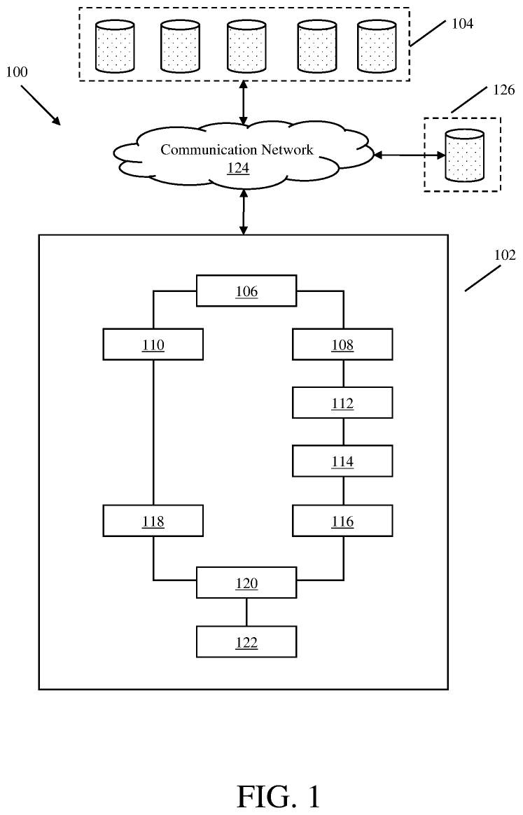

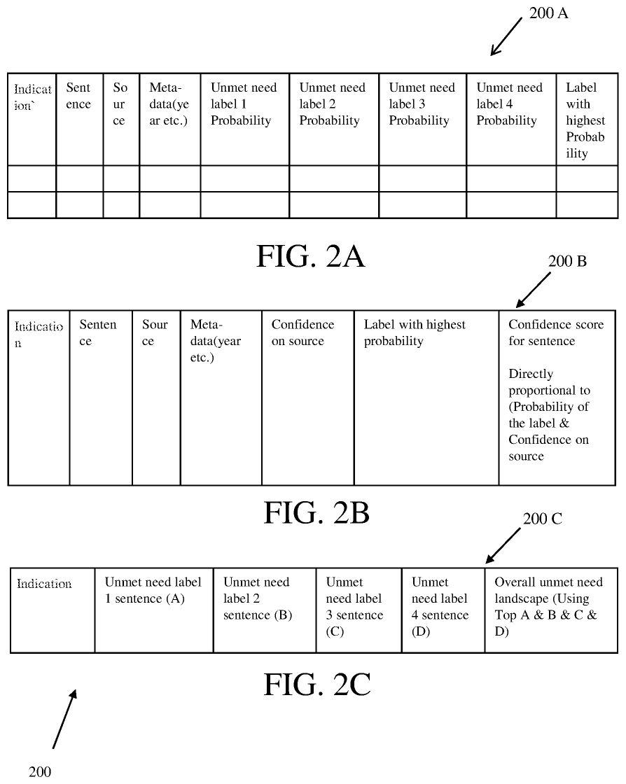

FIG. 1 is a block diagram that illustrates an exemplary system for identifying unmet medical need of an indication. Referring to FIG. 1, a system 100 includes at least one server 102, a plurality of data sources 104, a database arrangement 126. The at least one server 102 comprises a crawling module 106, a scanning module 108, one or more natural language processing module 110, at least one tagging module 112, one domain specific ontology 114, at least one supervised ML classifier module 116, at least one medical literature document confidence scoring module 118, at least one aggregator module 120, and at least one indexing module 122. The at least one server 102, the plurality of data sources 104 and database arrangement 126 are communicable coupled via the communication network 124. FIG. 1 is described in conjunction FIGS. 2A, 2B and 2B.

The at least one server 102 further comprises a memory, a storage device, an input/output (I/O) device, a user interface, and a wireless transceiver. The plurality of data sources 104 are external or remote resources but communicatively coupled to the at least one server 102 via a communication network 124.

The at least one server 102 comprises one or more processors is configured to model (not shown) the plurality of sentences to identify contextually labelled one or more sentences comprising indications, one or more unmet medical need categories, one or more unmet medical need attributes, wherein the plurality of sentences are modelled using one or more of natural language processing techniques and supervised ML classifier. In an embodiment, the model comprises at least one natural language processing techniques comprising bag of words model operable to identify one or more sentences comprising an indication and one or more unmet medical need categories from the plurality of sentences, at a domain specific ontology operable to contextually identify the indication, one or more unmet medical need categories and one or more unmet medical need, and at least one supervised ML classifier operable to label the identified one or more sentences with one or more unmet medical need attributes corresponding to the one or more unmet medical need categories.

In some embodiment of the disclosure, the crawling module 106, the scanning module 108, the one or more natural language processing module 110, the at least one tagging module 112, the domain specific ontology 114, the at least one supervised ML classifier module 116, the at least one medical literature document confidence scoring module 118, at least one aggregator module 120, and at least one indexing module 122 are integrated with other processors and modules to form an integrated system. In some embodiments of the disclosure the one or more processors of the at least one server 102 may be integrated in any order and other combination modules to form an integrated system. In some embodiments of the disclosure, as shown, the crawling module 106, the scanning module 108, the one or more natural language processing module 110, the at least one tagging module 112, the domain specific ontology 114, the at least one supervised ML classifier module 116, the at least one medical literature document confidence scoring module 118, at least one aggregator module 120, and at least one indexing module 122 and the one or more processors may be distinct from each other. Other separation and/or combination of the various processing engines and entities of the exemplary system 100 illustrated in FIG. 1 may be done without departing from the spirit and scope of the various embodiments of the disclosure.

The plurality of data sources 104 may correspond to a plurality of public resources, such as servers, programs, and machines, that may store biological, biomedical, and medical literature documents comprising of survey data, healthcare news, articles, guidelines, SOC documents, experimental data relevant to unmet medical need and may serve as a starting point for identification of the unmet medical need of the indication. In accordance with an embodiment, the plurality of data sources 104 may provide the medical literature documents datasets to the at least one server 102 upon receiving instructions from the at least one server 102. The instructions correspond instructing the crawling module 106 to extract relevant medical literature documents.

Notwithstanding, various types of the plurality of data sources 104, as exemplified above, should not be construed to be limiting, and various other types of plurality of data sources 104 may also be used, without deviation from the scope of the disclosure.

The crawling module 106 may comprise suitable libraries, logic, and/or code that may be operable to implement the crawling function in conjunction with the one or more processors. More specifically, the crawling function, in conjunction with the one or more processors, may enable the at least one server 102 to extract medical literature documents disclosing contents related to the unmet medical needs. In an embodiment, the crawling module 106 in conjunction with other modules, functions, logic and one or more algorithms identify synonyms and abbreviations for the unmet medical needs, the indications, one or more unmet medical need categories, and the one or more unmet medical need attributes to extract the plurality of medical literatures from the plurality of data sources 104. In other embodiment, the crawling module 106 forms an integrated system comprising of the one or more natural language processing module 110, the domain specific ontology 114, and the at least one supervised ML classifier module 116 to efficiently extract the plurality of medical literature documents comprising the unmet medical needs, the indications, one or more unmet medical need categories, and the one or more unmet medical need attributes.

The scanning module 108 comprise suitable libraries, logic, and/or code that may be operable to implement the scanning function in conjunction with the one or more processors. More specifically, the scanning function, in conjunction with the one or more processors, may enable the at least one server 102 to extract and tokenize the medical literature documents into plurality of sentences. In an embodiment, the scanning module 108 is operable to scan text, pdf, images, tables and other forms to extract and tokenize the medical literature documents. In another embodiment, the scanning module 108 in conjunction with one or more modules convert the medical literature documents into JavaScript Object Notation (JSON) to extract and tokenize the medical literature documents. In an embodiment, the scanning module 108 is operable to be connected with the one or more natural language processing module 110.

The one or more natural language processing module 110 comprises of bag of words model to identify one or more sentences comprising an indication and one or more unmet medical need categories. The one or more natural language processing module 110 comprises of suitable libraries, logic, and/or code to implement the bag of words model in conjunction with the one or more processors and one or more modules. More specifically, the one or more natural language processing module 110 identifies one or more sentences from the plurality of sentences associated with at least one medical literature document. In an embodiment, the bag of words model the frequency of each word in a sentence is used as a feature for training a classifier. In an embodiment, the bag of words models represents text documents as vectors of identifiers, for examples, as index terms). The bag of words model is used in information filtering, information retrieval, indexing and relevancy rankings. In another embodiment, the one or more natural language processing module 110 implements an n-gram model to store spatial information of the plurality of sentence to identify the one or more sentences comprising the indications and one or more unmet medical needs categories. Beneficially, the identified one or more sentences are further processed to identify the unmet medical needs of the indication; and the other public literature documents which do not contain one or more sentences corresponding the indications and the one or more unmet medical need categories are discarded.

In an embodiment, the at least one server 102 is configured to receive the indications, one or more unmet medical need categories, and the one or more unmet medical need attributes manually. In an embodiment, the at least one server 102 stores indications, one or more unmet medical need categories, and the one or more unmet medical need attributes in the database 126. In an embodiment, the one or more unmet medical need attributes comprises of efficacy, targets, route of administration, no or less therapeutic, diagnostic unavailable. In an example, for a medical literature document titled, “Identifying Unmet Care Needs and Important Treatment Attributes in the Management of Hidradenitis Suppurativa: A Qualitative Interview Study” available at one or more data sources. It is manually identified that medical literature document contains indication corresponding to “Hidradenitis Suppurativa”, the one or more unmet medical need categories-“Treatment outcome-related unmet care need, Care process-related unmet care need, and Treatment attribute”, and the one or more unmet medical need attributes are “QoL impact, Effectiveness, Pain control, Duration of effect, Side effects, Disease progression, Skin appearance, Time to onset, Timely diagnosis, Disease awareness, Healthcare system settings, Wound care guidance, Treatment selection process, Access to HS specialists, Wound care costs”. In an embodiment, the above definitions have the following unmet need sentence corpus corresponding to the one or more unmet medical need attributes—“Lacking improvement of general or skin-specific QoL; mental health; productivity; social life; intimacy issues; lifestyle restrictions”, “Insufficient control or reduction of lesions, nodules, or draining fistulas; lacking effect on inflammation, flares, or other symptoms; low treatment response rate, efficacy, or likelihood of response; insufficient patient satisfaction”, “Inadequate pain reduction, control, or improvement”, “Poor maintenance of effect; low durability of effect; frequent loss of response or disease recurrence”, “Concerning antibiotics or biologic side effects; drug—drug interactions; comorbidity implications; life implications of surgery”, “Inadequate halting of disease progression or worsening of disease”, “Dissatisfying visual or odor appearance of skin affected by disease or scarring”, “Slow onset of effect or treatment response; difficult early prediction of later treatment success”, “Delayed, wrong, or no diagnosis provided”, “Poor general awareness or knowledge of HS; inadequate care provision until correct diagnosis”, “Inadequate healthcare system care set-up; lacking care integration, follow-up, or self-care guidance; long geographic distance to HS specialist; care inefficiencies due to fragmented care provision”, “Insufficient patient and nurse education on HS-specific wound care; lacking published guidance or information”.

Notwithstanding, various types of the indications, one or more unmet medical need categories, and the one or more unmet medical need attributes, as exemplified above, should not be construed to be limiting, and various other types of indications, one or more unmet medical need categories, and the one or more unmet medical need attributes may also be pre-defined, without deviation from the scope of the disclosure.

In an embodiment, the at least one server 102 comprises of suitable libraries, logics, modules, and/or code operable to identify synonyms and abbreviations for the indications, one or more unmet medical need categories, and the one or more unmet medical need attributes to identify the one or more sentences in the plurality of publications. In an embodiment, the at least one server 102 applies the one or more algorithms to the indications, one or more unmet medical need categories, and the one or more unmet medical need attributes to identify the synonyms, abbreviations and other terms for identification of similar terms. In another embodiment, the at least one server comprise of translation modules (not shown) to translate text from other languages to facilitate the identification of unmet medical needs.

The at least one tagging module 112 comprises of suitable logic, algorithms, libraries, and/or code that implement one or more tagging function to tag the identified one or more sentences with metadata of the respective medical literature documents. In an embodiment, the metadata associated with medical literature documents include title, authors, qualification and achievement of the authors, date of the publication, citations in the publication, forward citation of the publication, and impact factor of the publisher. Beneficially the at least one tagging module 112 tags the identified one or more sentences with the metadata of the respective medical literature document while discarding the other publications and sentences unrelated to the indications and the one or more unmet medical need categories. In the implementation, the at least one tagging module 112 employs automatic tagging libraries, algorithms, code, and/or logic to tag the identified one or more sentences. In an embodiment, the at least one tagging module 112 is operable to connect with the at least one medical literature document confidence scoring module 118 to determine a source confidence score of the at least one medical literature document.

The domain specific ontology 114 is operable to contextually identify the indication, one or more unmet medical need categories and one or more unmet medical need attributes and the associations between them. The at least one domain specific ontology 114 further comprises of suitable libraries, logics, modules, and/or code operable to contextually identify the indication, one or more unmet medical need categories and one or more unmet medical need attributes and the associations between them. Beneficially, the domain specific ontology 114 (or knowledge graphs) enables the classification of vast amounts of data that is put into a context for the purpose of creating structured information from the identified one or more sentences. Further beneficially, the domain specific ontology 114 identifies and categorize key information (entities) in unstructured text. The key information entities comprise one or more unmet medical need attributes and indications. In an embodiment, a trained NER machine learning model considers the unannotated text and produces an annotated text, highlighting the names of entities associated with the indications and one or more unmet medical need attributes. In an embodiment, the domain specific ontology 114 identifies the context associated with the indications and one or more unmet medical need categories in terms of its synonyms and associated company, brand name, approval date, patents, pathways, biosimilars, target indications etc. In an embodiment, the domain specific ontology includes Key Opinion Leader (KOL) who publishes the most on the specific indication, their affiliation, and their relationships with co-authors and other KOLs.

The at least one supervised ML classifier module 116 is operable to label the identified one or more sentences with one or more unmet medical need attributes corresponding to the one or more unmet medical need categories. The at least one supervised ML classifier module 116 further comprises of suitable libraries, logics, modules, and/or code operable to label the identified one or more sentences with one or more unmet medical need attributes. The The at least one supervised ML classifier module 116 minimizes unwarranted, arbitrary annotative semantic label assignments for textual entities.

Specifically, the at least one supervised ML classifier module 116 is operable to label the identified one or more sentences with one or more unmet medical need attributes corresponding to the one or more unmet medical need categories. In an embodiment, the at least one supervised ML classifier module 116 is operable to determine a probability of the accuracy of the labelled one or more sentences. The at least one supervised ML classifier module 116 considers the contextually identified the indication, one or more unmet medical need categories and one or more unmet medical need attributes and the associations between them to further label them and determine a probability of the labelling. In an embodiment, the one or more unmet medical need attributes includes efficacy related, targets related, Route of administration related, No or less therapeutic related, diagnostic unavailable, etc to prepare an unmet need landscape of the indication. Further, the at least one supervised ML classifier comprises of training data, suitable libraries, and/or code that are operable to implement ML techniques in conjunction with one or more processors. The training data for the at least one supervised ML classifier module 116 is prepared using predefined and collected phrases for the unmet medical need. The identified one or more sentences are passed for validation and classification. The at least one supervised ML classifier module 116 is trained on the unmet need sentence corpus for distinguishing on the variety of sentences. In an embodiment, the at least one supervised ML classifier module 116 helps in categorizing and segregating sentences into the predefined labels. For example, “Lack of understanding of disease pathophysiology” is a blocker for new therapeutics for breast cancer” is labeled as ‘target related’. Similarly, “Thus, effective treatments for fatigue in prostate cancer survivors represent a current unmet need” is labeled as ‘efficacy related. Further, “This unmet need has led to recent advances in therapy aimed at treating bone metastases” is ‘treatment related’. Beneficially, the at least one supervised ML classifier module 116 considers context of the labels rather than presence of words in a sentence thus advantageous over keyword-based classification. In an embodiment, FIG. 2A, provides the output after iterations of the at least one supervised ML classifier module 116. Specifically, the output of the at least one supervised ML classifier module 116 comprises the indications, the one or more identified sentences, the at least one medical literature document associated with the identified sentences, Metadata of the at least one medical literature document, unmet need label 1 probability, unmet need label 2 probability, unmet need label 3 probability, unmet need label 4 probability, and label with highest probability.

The at least one medical literature document confidence scoring module 118 comprises of suitable logic, libraries and/or code that are operable to generate a source confidence score for the respective plurality of medical literature documents based on recency of the document and impact factor of the medical literature document. In an embodiment, the at least one medical literature document confidence scoring module 118 receives input from the at least one tagging module 112 and the at least one supervised ML classifier module 116 to generate contextually relevant labelled one or more sentences. In an embodiment, the different medical literature documents are weighed differently to generate the source confidence score. The medical literature documents are weighed in the order of—standard of care document, guidelines, publications, news, congress articles and thesis. Further, each medical literature document is internalized with the year of publication—higher the recency, higher the confidence score. Moreover, each medical literature document is internalized with the confidence of the source using different standard indexes for each source-impact factor of the publisher, grade of the congress, altmetric score of the news. FIG. 2B, provides an illustration of the source confidence score generated with each metric along with the output generated by at least one medical literature document confidence scoring module 118 from the domain specific ontology 114 and the at least one supervised ML classifier module 116. In an embodiment, the output generated are—indications, one or more identified sentences, at least one medical literature document, a probability of the labelled one or more sentences, label with highest probability, probability of the label and confidence score for the identified sentences is directly proportional to the probability of the label and source confidence score.

The at least one aggregator module 120 comprises of suitable libraries, logic, and/or code to aggregate the medical literature documents based on the probability of the labelled sentences and the source confidence score. In an embodiment, the at least one aggregator module 120 receives the input from the at least one medical literature document confidence scoring module 118 and the at least one supervised ML classifier module 116 to aggregate the medical literature documents. In an embodiment, the medical literatures are aggregated based on the one or more unmet medical need attributes. Referring to FIG. 2C, the figure illustrates the output from the at least one aggregator module 120. In an embodiment, the output of the at least one aggregator module 120 are indications, unmet medical label 1 sentences (A), unmet medical label 2 sentences (B), unmet medical label 3 sentences (C), unmet need label sentences (D), overall unmet need landscape (top A, B, C&D).

The at least one indexing module 122 comprising of suitable libraries, logic and/or code is operable to store the modelled contextually relevant labelled one or more sentences, the indications, one or more unmet medical need categories, one or more unmet medical need attributes, the probability, and source confidence score to extract the unmet medical needs of the indications from the one or more medical literature documents in the database 126. In an embodiment, the indexing module 122 interactively stores the above in mongoDB. In an embodiment, the at least one indexing module 122 creates the index in elastic search to enable retrieval by querying indications, one or more unmet medical need categories, and one or more unmet medical need attributes.

The database 126 may be capable of providing mass storage to the at least one server 102. In some embodiments, the database 126 may be or contain a computer-readable medium, such as a hard disk device, an optical disk device, or a tape device, a flash memory or other similar solid state memory device, or an array of devices, including devices in a storage area network or other configurations. A computer program product may be tangibly embodied in an information carrier. The information carrier may be a computer-readable or machine-readable medium, such as database 126. The computer program product may also contain instructions that, when executed, perform one or more methods, such as those described in the disclosure.

A user interface (not shown) may comprise suitable logic, circuitry, and interfaces that may be configured to present the results i.e., the unmet medical needs of the indications. In an embodiment, the user interface displays one or more medical literature documents for queries corresponding to one of the indications or the one or more unmet medical need attributes based on the index. The results are presented in form of an audible, visual, tactile, or other output to the user, such as a researcher, a scientist, a principal investigator, data manager, and a health authority, associated with the at least one server 102. As such, the user interface may include, for example, a display, one or more switches, buttons, or keys (e.g., a keyboard or other function buttons), a mouse, and/or other input/output mechanisms. In an example embodiment, the user interface may include a plurality of lights, a display, a speaker, a microphone, and/or the like. In some embodiments, the user interface may also provide interface mechanisms that are generated on the display for facilitating user interaction. Thus, for example, the user interface may be configured to provide interface consoles, web pages, web portals, drop down menus, buttons, and/or the like, and components thereof to facilitate user interaction.

The communication network 124 may be any kind of network, or a combination of various networks, and it is shown illustrating exemplary communication that may occur between the plurality of data sources 104 and the at least one server 102. For example, the communication network 124 may comprise one or more of a cable television network, the Internet, a satellite communication network, or a group of interconnected networks (for example, Wide Area Networks or WANs), such as the World Wide Web. Although one mode of communication network the communication network 124 is shown, the disclosure is not limited in this regard. Accordingly, other exemplary modes may comprise uni-directional or bi-directional distribution, such as packet-radio, and satellite networks.

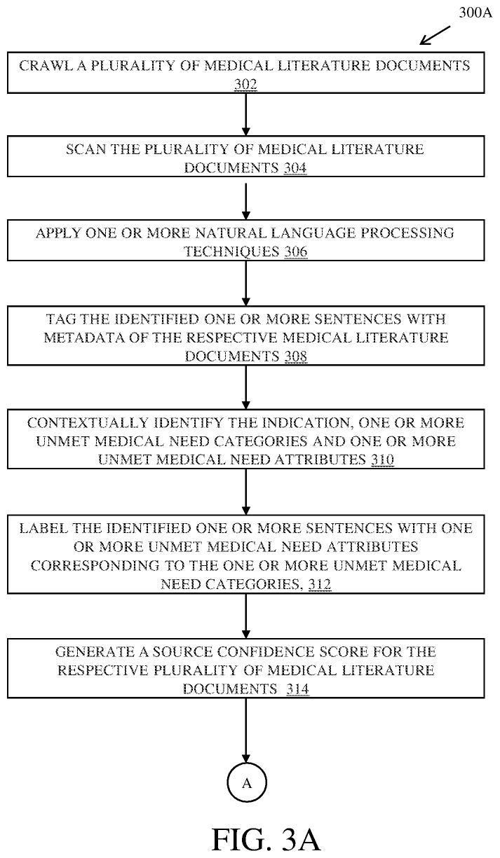

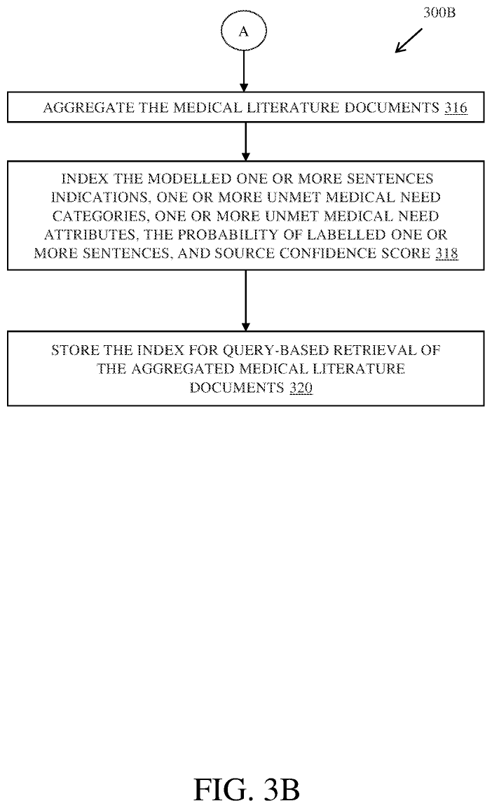

FIGS. 3A and 3B depict flowcharts illustrating exemplary operations for identifying unmet medical needs of an indication. Flowcharts 300A and 300B of FIGS. 3A and 3B respectively, are described in conjunction with FIG. 1.

At step 302, plurality of medica literature documents are crawled from the plurality of data sources based on unmet medical needs. In accordance with an embodiment, the at least one crawling module is configured to crawl the plurality of data sources to extract medical literature documents disclosing contents related to the unmet medical needs. For the retrieval, the plurality of data sources 104 may be accessed using via the communication network 124.

At step 304, the plurality of medical literature documents are scanned for extracting and tokenizing the medical literature documents into plurality of sentences. In an embodiment, the plurality of medical literature documents are scanned using the scanning module 108 in conjunction with one or more modules convert the medical literature documents into JavaScript Object Notation (JSON) to extract and tokenize the medical literature documents into a plurality of sentences.

At step 306, one or more natural language processing techniques are applied to the plurality of sentences to identify one or more sentences comprising of indications and one or more unmet medical need categories. The one or more natural language processing techniques includes bag of words model to identify the frequency of indications and one or more unmet medical need categories to find the relevant sentences comprising the indications ana one or more unmet medical need categories.

At step 308, the metadata of respective medical literature is tagged with the identified one or more sentences. In an embodiment, the metadata associated with medical literature documents includes title, authors, qualification and achievement of the authors, date of the publication, citations in the publication, forward citation of the publication, and impact factor of the publisher.

At step 310, the one or more unmet medical need attributes corresponding to the one or more medical need categories are contextually identify the indication, one or more unmet medical need categories and one or more unmet medical need attributes. The one or more unmet medical need attributes, the one or more medical need categories and the indications are pre-defined to label them against the identified sentences. In an embodiment, the domain specific ontology 114 are configured to contextually identify the indication, one or more unmet medical need categories and one or more unmet medical need attributes.

At step 312, label the identified one or more sentences with one or more unmet medical need attributes corresponding to the one or more unmet medical need categories by the at least one supervised ML classifier module 116. In an embodiment, at least one supervised ML classifier module 116 is trained on the unmet need sentence corpus for distinguishing on the variety of sentences and determine the associated probability of the labelled one or more sentences.

At step 314, a source confidence score for the respective plurality of medical literature documents is generated by at least one medical literature document confidence scoring module 118. In an embodiment, the source confidence score for the respective plurality of medical literature documents is generated based on recency of the document and impact factor of the medical literature document.

At step 316, the medical literature documents are aggregated based on the on the probability of the labelled sentences and the source confidence score. In an embodiment, the medical literature documents are aggregated based on the input from the at least one medical literature document confidence scoring module 118 for source confidence score and the at least one supervised ML classifier module 116 for the probability of the label.

At step 318, the modelled one or more sentences, the indications, the one or more unmet medical need categories, the one or more unmet medical need attributes, the probability of the labels and the source confidence score is indexed. In an embodiment, the at least one indexing module 122 creates the index in elastic search to enable retrieval by querying indications, one or more unmet medical need categories, and one or more unmet medical need attributes.

At step 320, index is stored in the database 126 for efficient retrieval of the medical literature documents, the indications, the one or more unmet medical need categories, the one or more unmet medical need attributes, the probability of the labelled sentences and the source confidence.

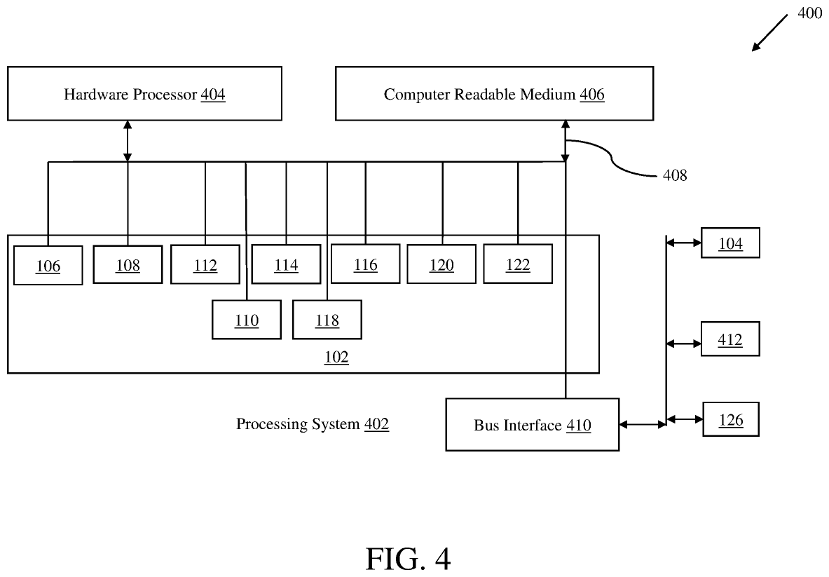

FIG. 4 is a conceptual diagram illustrating an example of a hardware implementation for a system employing a processing system for identifying unmet medical need of an indication, in accordance with an exemplary embodiment of the disclosure. Referring to FIG. 4, the hardware implementation shown by a representation 400 for the at least one server 102 that employs a processing system 402 for identifying unmet medical need of an indication, as described herein.

In some examples, the processing system 402 may comprise one or more instances of a hardware processor 404, a non-transitory computer-readable medium 406, a bus 408, a bus interface 410, and a transceiver 412. FIG. 4 further illustrates the at least one server 102 comprising the crawling module 106, a scanning module 108, one or more natural language processing module 110, at least one tagging module 112, one or more name entity recognition module 114, at least one supervised ML classifier module 116, at least one medical literature document confidence scoring module 118, at least one aggregator module 120, and at least one indexing module 122, as described in detail in FIG. 1.

The hardware processor 404, such as the processor, may be configured to manage the bus 408 and general processing, including the execution of a set of instructions stored on the computer-readable medium 406. The set of instructions, when executed by the hardware processor 404, causes the at least one server 102 to execute the various functions described herein for any particular apparatus. The hardware processor 404 may be implemented, based on several processor technologies known in the art. Examples of the hardware processor 404 may be RISC processor, ASIC processor, CISC processor, and/or other processors or control circuits.

The non-transitory computer-readable medium 406 may be used for storing data that is manipulated by the hardware processor 404 when executing the set of instructions. The data is stored for short periods or in the presence of power. The computer-readable medium 406 may also be configured to store data for one or more of the crawling module 106, a scanning module 108, one or more natural language processing module 110, at least one tagging module 112, one or more name entity recognition module 114, at least one supervised ML classifier module 116, at least one medical literature document confidence scoring module 118, at least one aggregator module 120, and at least one indexing module 122.

The bus 408 may be configured to link together various circuits. In this example, the at least one server 102 employing the processing system 402 and the non-transitory computer-readable medium 406 may be implemented with bus architecture, represented generally by bus 408. The bus 408 may include any number of interconnecting buses and bridges depending on the specific implementation of the at least one server 102 and the overall design constraints. The bus interface 410 may be configured to provide an interface between the bus 408 and other circuits, such as, the transceiver 412, and external devices, such as the plurality of data sources 104.

The transceiver 412 may be configured to provide a communication of the at least one server 102 with various other apparatus, such as the plurality of data sources 104, via a network. The transceiver 412 may communicate via wireless communication with networks, such as the Internet, the Intranet and/or a wireless network, such as a cellular telephone network, a wireless local area network (WLAN) and/or a metropolitan area network (MAN). The wireless communication may use any of a plurality of communication standards, protocols and technologies, such as 5th generation mobile network, Global System for Mobile Communications (GSM), Enhanced Data GSM Environment (EDGE), Long Term Evolution (LTE), wideband code division multiple access (W-CDMA), code division multiple access (CDMA), time division multiple access (TDMA), Bluetooth, Wireless Fidelity (Wi-Fi) (such as IEEE 802.11a, IEEE 802.11b, IEEE 802.11g and/or IEEE 802.11n), voice over Internet Protocol (VoIP), and/or Wi-MAX.

It should be recognized that, in some embodiments of the disclosure, one or more components of FIG. 4 may include software whose corresponding code may be executed by at least one processor, for across multiple processing environments. For example, the crawling module 106, a scanning module 108, one or more natural language processing module 110, at least one tagging module 112, one or more name entity recognition module 114, at least one supervised ML classifier module 116, at least one medical literature document confidence scoring module 118, at least one aggregator module 120, and at least one indexing module 122, may include software that may be executed across a single or multiple processing environments.

In an aspect of the disclosure, the hardware processor 404, the non-transitory computer-readable medium 406, or a combination of both may be configured or otherwise specially programmed to execute the operations or functionality of crawling module 106, a scanning module 108, one or more natural language processing module 110, at least one tagging module 112, one or more name entity recognition module 114, at least one supervised ML classifier module 116, at least one medical literature document confidence scoring module 118, at least one aggregator module 120, and at least one indexing module 122, or various other components described herein, as described with respect to FIGS. 1 to 3.

Certain embodiments of the present invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and/or code (if any is necessary) to perform the function, regardless of whether performance of the function is disabled, or not enabled, by some user-configurable setting.

The terminology used herein is for the purpose of describing particular embodiments only and is not intended to be limiting of embodiments of the disclosure. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any non-transitory form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Another embodiment of the disclosure may provide a non-transitory machine and/or computer-readable storage and/or media, having stored thereon, a machine code and/or a computer program having at least one code section executable by a machine and/or a computer, thereby causing the machine and/or computer to perform the steps as described herein for determining combination drug and use in pancreatic cancer treatment.

The present disclosure may also be embedded in a computer program product, which comprises all the features enabling the implementation of the methods described herein, and which when loaded in a computer system is able to carry out these methods. Computer program in the present context means any expression, in any language, code or notation, either statically or dynamically defined, of a set of instructions intended to cause a system having an information processing capability to perform a particular function either directly or after either or both of the following: a) conversion to another language, code or notation; b) reproduction in a different material form.

Further, those of skill in the art will appreciate that the various illustrative logical blocks, modules, circuits, algorithms, and/or steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the embodiments disclosed herein may be embodied directly in firmware, hardware, in a software module executed by a processor, or in a combination thereof. A software module may reside in RAM memory, flash memory, ROM memory, EPROM memory, EEPROM memory, registers, hard disk, physical and/or virtual disk, a removable disk, a CD-ROM, virtualized system or device such as a virtual server or container, or any other form of storage medium known in the art. An exemplary storage medium is communicatively coupled to the processor (including logic/code executing in the processor) such that the processor can read information from, and write information to, the storage medium. In the alternative, the storage medium may be integral to the processor.

While the present disclosure has been described with reference to certain embodiments, it will be noted understood by, for example, those skilled in the art that various changes and modifications could be made and equivalents may be substituted without departing from the scope of the present disclosure as defined, for example, in the appended claims. In addition, many modifications may be made to adapt a particular situation or material to the teachings of the present disclosure without departing from its scope. The functions, steps and/or actions of the method claims in accordance with the embodiments of the disclosure described herein need not be performed in any particular order. Furthermore, although elements of the disclosure may be described or claimed in the singular, the plural is contemplated unless limitation to the singular is explicitly stated. Therefore, it is intended that the present disclosure is not limited to the particular embodiment disclosed, but that the present disclosure will include all embodiments falling within the scope of the appended claims.

What is claimed is:

1. A method for retrieval of contextual information related to unmet medical need of an indication, comprising of
scanning, by one or more processors, plurality of medical literature documents to extract and tokenize the documents into plurality of sentences,
modelling, by one or more processors, the plurality of sentences to identify contextually labelled one or more sentences comprising indications, one or more unmet medical need categories, one or more unmet medical need attributes, wherein the plurality of sentences are modelled using one or more of natural language processing techniques and supervised ML classifier,
indexing, by one or more processors, the modelled contextually labelled one or more sentences, the indications, one or more unmet medical need categories, one or more unmet medical need attributes to retrieve the contextual information related to the unmet medical needs of the indications.

2. The method as claimed in claim 1, wherein the model comprises:
at least one natural language processing techniques comprising bag of words model operable to identify one or more sentences comprising an indication and one or more unmet medical need categories from the plurality of sentences,
a domain specific ontology operable to contextually identify the indication, one or more unmet medical need categories and one or more unmet medical need attributes, and
at least one supervised ML classifier operable to label the identified one or more sentences with one or more unmet medical need attributes corresponding to the one or more unmet medical need categories.

3. The method as claimed in claim 1, wherein the method comprises tagging, by one or more processors, the identified one or more sentences with metadata of the respective medical literature documents.

4. The method as claimed in claim 1, wherein the method comprises of generating, by one or more processors, a source confidence score for the respective plurality of medical literature documents based on recency of the document and impact factor of the medical literature document.

5. The method as claimed in claim 1, wherein the method comprises aggregating, by one or more processors, the medical literature documents based on the contextually modelled one or more sentences and the source confidence score.

6. The method as claimed in claim 1, wherein the method comprises crawling, by one or more processors, plurality of data sources to extract plurality of medical literature documents.

7. The method as claimed in claim 1, wherein the indications, one or more unmet medical need categories, and the one or more unmet medical need attributes are pre-defined, wherein the one or more unmet medical need attributes comprises of efficacy, targets, Route of administration, No or less therapeutic, diagnostic unavailable.

8. The method as claimed in claim 2, wherein the method comprises applying, by one or more processors, one or more algorithms to identify synonyms and abbreviations for the indications, one or more unmet medical need categories, and the one or more unmet medical need attributes to identify the one or more sentences.

9. The method as claimed in claim 1, wherein the method comprises displaying, by one or more processors, one or more medical literature documents for queries corresponding to one of the indications or the one or more unmet medical need attributes based on the index.

10. The method as claimed in claim 1, wherein the medical literature documents comprise of survey data, healthcare news, articles, guidelines, SOC documents, experimental data.

11. A system for retrieval of contextual information related to unmet medical need of an indication, comprising:
at least one server communicably coupled with a plurality of data sources and a database, comprising one or more processors configured to:
scan a plurality of medical literature documents to extract and tokenize the documents into plurality of sentences;
model the plurality of sentences to identify contextually labelled one or more sentences comprising indications, one or more unmet medical need categories, one or more unmet medical need attributes, wherein the plurality of sentences are modelled using one or more of natural language processing techniques and supervised ML classifier; and
index the modelled contextually labelled one or more sentences, the indications, one or more unmet medical need categories, one or more unmet medical need attributes to retrieve the one or more medical literature documents and contextual information related to the unmet medical needs of the indications; and
the database arrangement is configured to store the index for query-based retrieval of the contextual information related to unmet medical need of an indication.

12. The system as claimed in claim 11, wherein the model comprises:
at least one natural language processing techniques comprising bag of words model operable to identify one or more sentences comprising an indication and one or more unmet medical need categories from the plurality of sentences,
a domain specific ontology operable to contextually identify the indication, one or more unmet medical need categories and one or more unmet medical need, and
at least one supervised ML classifier operable to attributes label the identified one or more sentences with one or more unmet medical need attributes corresponding to the one or more unmet medical need categories.

13. The system as claimed in claim 11, the at least one server comprising one or more processors configured to tag the identified one or more sentences with metadata of the respective medical literature documents.

14. The system as claimed in claim 11, the at least one server comprising one or more processors configured to generate a source confidence score for the respective plurality of medical literature documents based on recency of the document and impact factor of the medical literature document.

15. The system as claimed in claim 11, the at least one server comprising one or more processors configured to aggregate the medical literature documents based on the contextually labelled one or more sentences and the source confidence score.

16. The system as claimed in claim 11, the at least one server comprising one or more processors configured to crawl the plurality of data sources to extract plurality of medical literature documents.

17. The system as claimed in claim 11, wherein the indications, one or more unmet medical need categories, and the one or more unmet medical need attributes are pre-defined, wherein the one or more unmet medical need attributes comprises of efficacy, targets, Route of administration, No or less therapeutic, diagnostic unavailable.

18. The system as claimed in claim 12, the at least one server comprising one or more processors configured to apply one or more algorithms to identify synonyms and abbreviations for the indications, one or more unmet medical need categories, and the one or more unmet medical need attributes to identify the one or more sentences.

19. The system as claimed in claim 11, the at least one server comprising one or more processors configured to display the contextual information related to the unmet medical needs of the indications for queries corresponding to one of the indications or the one or more unmet medical need attributes based on the index.

20. A computer program product comprising a computer useable medium having computer program logic recorded thereon for enabling a processor to retrieve contextual information related to unmet medical need of an indication, the computer program logic comprising:
scan plurality of medical literature documents to extract and tokenize the documents into plurality of sentences,
model the plurality of sentences to identify contextually labelled one or more sentences comprising indications, one or more unmet medical need categories, one or more unmet medical need attributes, wherein the plurality of sentences are modelled using one or more of natural language processing techniques and supervised ML classifier,
index the modelled contextually labelled one or more sentences, the indications, one or more unmet medical need categories, one or more unmet medical need attributes to retrieve the contextual information related to the unmet medical needs of the indications.
